(19) United States
(12) Patent Application Publication
(10) Pub. No.: US 2026/0067759 A1
(43) Pub. Date: Mar. 5, 2026

(54) METHODS FOR MANAGING MEASUREMENT CONFIGURATIONS WITH L1/L2 BASED MOBILITY

(71) Applicant: InterDigital Patent Holdings, Inc., Wilmington, DE (US)

(72) Inventors: Brian Martin, Farnham (GB); Oumer Teyeb, Montreal (CA); Martino Freda, Laval (CA); Paul Marinier, Brossard (CA)

(73) Assignee: InterDigital Patent Holdings, Inc., Wilmington, DE (US)

(21) Appl. No.: 18/992,274

(22) PCT Filed: Jul. 10, 2023
(86) PCT No.: PCT/US2023/027268

§ 371 Date: Jan. 8, 2025

Related U.S. Application Data
(60) Provisional application No. 63/388,111, filed on Jul. 11, 2022.
(60) Provisional application No. 63/394,888, filed on Aug. 3, 2022.
(60) Provisional application No. 63/465,115, filed on May 9, 2023.

(51) Int. Cl. H04W 36/00; H04W 24/10; H04W 36/08

(52) U.S. Cl. CPC H04W 36/0058; H04W 24/10; H04W 36/08

(57) ABSTRACT

A wireless transmit/receive unit (WTRU) is configured with multiple conditional handover and/or measurement reporting configurations. The WTRU activates or deactivates one or more of the multiple configurations depending on various conditions, such as the change of the primary cell (PCell), a combination of currently active secondary cells (SCells) in the configured set of candidate L1/L2 mobility cells, or depending on specific changes in the combination of currently active cells in the configured set of candidate L1/L2 mobility cells. A conditional reconfiguration may be executed that updates the set of candidate L1/L2 mobility cells. A list of mobility area indexes may be included in the configuration, such as including an associated set of conditions for activating a particular area or a set of configurations to activate when the index is activated.

### CROSS REFERENCE TO RELATED APPLICATIONS

This application is the 371 National Stage of International Application No. PCT/US2023/027268, filed Jul. 10, 2023, which claims the benefit of U.S. Provisional Application No. 63/388,111 filed Jul. 11, 2022, U.S. Provisional Application No. 63/394,888 filed Aug. 3, 2022, and U.S. Provisional Application No. 63/465,115 filed May 9, 2023, the entire contents of which are incorporated herein by reference.

### BACKGROUND

A wireless transmit/receive unit (WTRU) may be configured with multiple conditional handover (HO) and/or measurement reporting configurations. The WTRU may be set to activate or deactivate various configurations based on one or more conditions. In 3GPP Release 18, the work item (WI) on “Further NR Mobility Enhancements” includes several objectives related to this background.

### SUMMARY

A wireless transmit/receive unit (WTRU) may comprise a processor configured to receive configuration information. For example, the configuration information may indicate a plurality of mobility candidate cells and a plurality of measurement configurations. The WTRU may activate a first measurement configuration of a plurality of measurement configurations based on a first cell being a current serving cell for the WTRU. The WTRU may be configured to determine that a second measurement configuration of the plurality of measurement configurations is deactivated based on the first cell being a current serving cell for the WTRU. The WTRU may receive Layer 1 or Layer 2 (L1/L2) control signaling indicating that the WTRU is to perform mobility to a second cell. For example, the second cell may be one of the plurality of mobility candidate cells.

The WTRU may determine which of the plurality of measurement configurations are to be activated and which of the plurality of measurement configurations are not to be activated upon performing mobility to the second cell based on the second cell being a new serving cell for the WTRU and the mobility to the second cell causing an activation of a third cell of the plurality of mobility candidate cells as a secondary cell. For example, the second cell may be a primary cell. Furthermore, the second measurement configuration may be determined to be activated. The WTRU may perform one or more measurements associated with the second measurement configuration. The WTRU may send a measurement report via the second cell based on the measurements associated with the second measurement configuration. The plurality of measurement configurations may comprise channel state information (CSI) reporting configurations.

The L1/L2 control signaling comprises a medium access control (MAC) control element (CE). The WTRU may be configured to receive the configuration information indicating the plurality of mobility candidate cells independently of the plurality of measurement configurations. The L1/L2 control signaling may indicate a new special cell (SpCell) and an activated secondary cell (Scell). The WTRU may be configured to receive the plurality of measurement configurations accompanied by an association with one or more special cell (SpCell)/secondary cell (SCell) combinations. The WTRU may be configured to determine which of the plurality of measurement configurations are to be activated and which of the plurality of measurement configurations are not to be activated upon performing mobility to the second cell based on the one or more SpCell/SCell combinations.

The WTRU may be configured to determine which of the plurality of measurement configurations are to be activated and which of the plurality of measurement configurations are not to be activated upon performing mobility to the second cell based on a combination of currently active secondary cells (SCells) in the plurality of mobility candidate cells.

### BRIEF DESCRIPTION OF THE DRAWINGS

FIG. 1A is a system diagram illustrating an example communications system in which one or more disclosed embodiments may be implemented.

FIG. 1B is a system diagram illustrating an example wireless transmit/receive unit (WTRU) that may be used within the communications system illustrated in FIG. 1A according to an embodiment.

FIG. 1C is a system diagram illustrating an example radio access network (RAN) and an example core network (CN) that may be used within the communications system illustrated in FIG. 1A according to an embodiment.

FIG. 1D is a system diagram illustrating a further example RAN and a further example CN that may be used within the communications system illustrated in FIG. 1A according to an embodiment.

FIG. 2 shows an example of a basic handover scenario in NR.

FIG. 3 shows an example of a conditional handover configuration and execution.

FIG. 4 shows an example of an L1/L2 inter-cell mobility using carrier aggregation (CA).

FIG. 5 shows an example of an L1/L2 mobility area.

FIG. 6 shows an example of dynamic activation of a conditional handover (CHO) configuration.

FIG. 7 shows an example of dynamic activation of a CHO configuration.

FIG. 8 shows an example of the activation of a CHO/CPAC configuration depending on the current SpCell.

FIG. 9 shows another example of an L1/L2 mobility area.

FIG. 10 shows a flowchart for measurement configurations with L1/L2 based mobility

### DETAILED DESCRIPTION

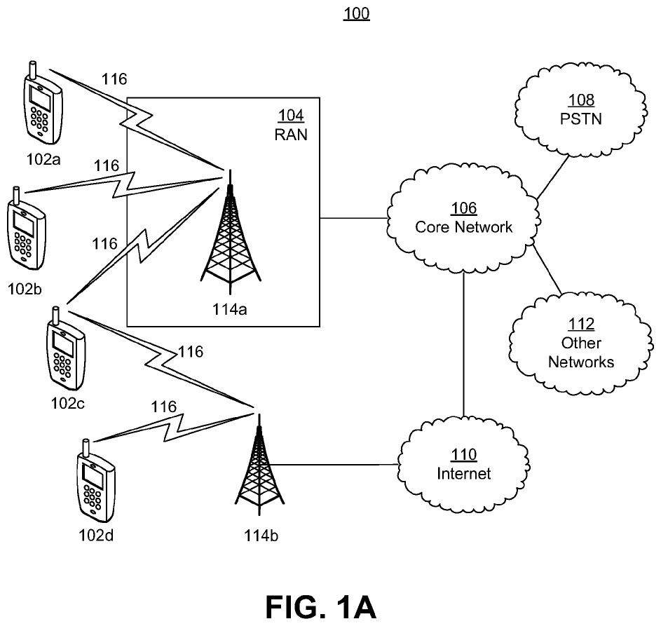

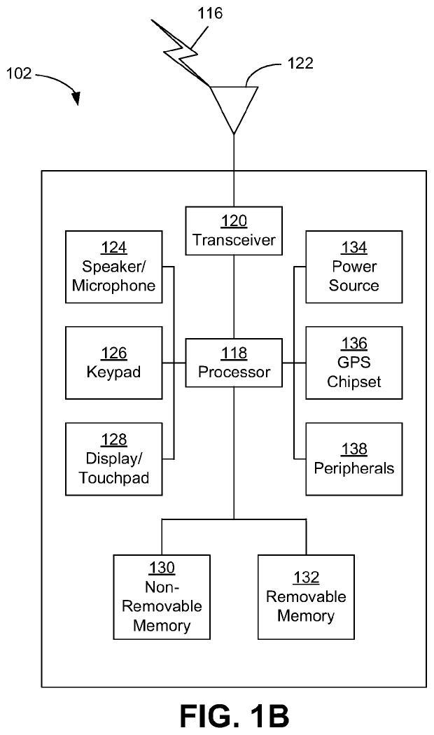

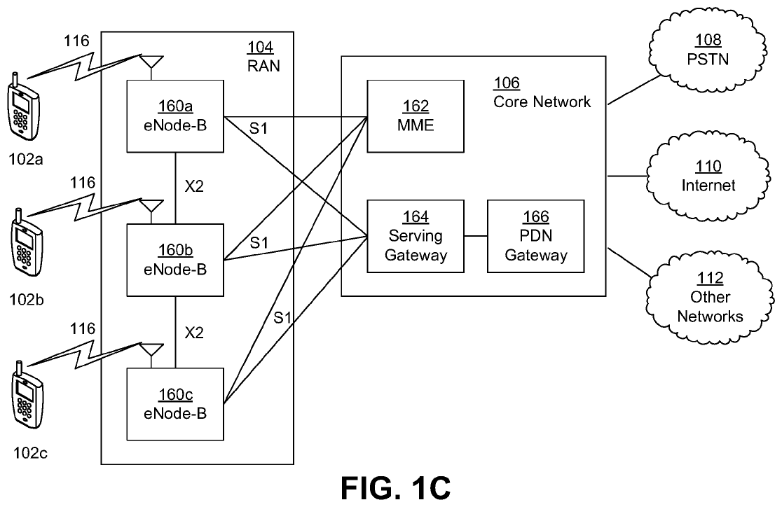

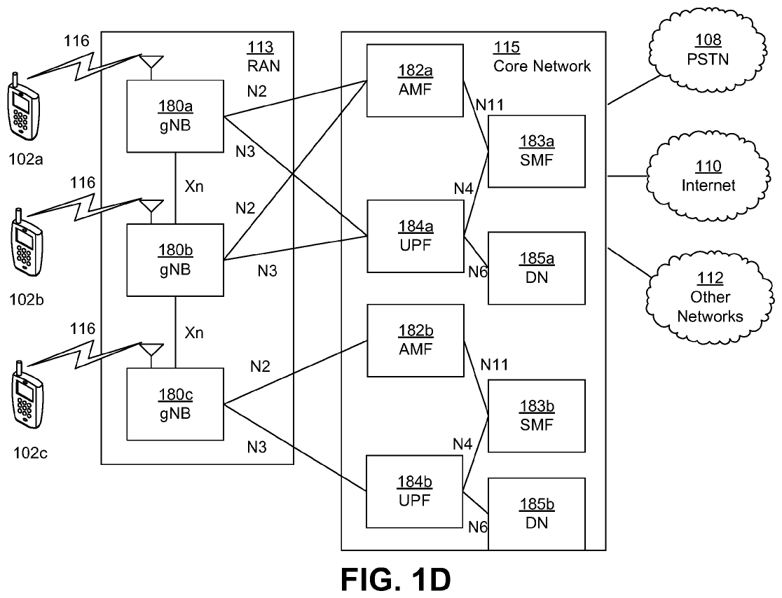

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word DFT-Spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include WTRUs 102a, 102b, 102c, 102d, a RAN 104/113, a CN 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (for example, remote surgery), an industrial device and applications (for example, a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a WTRU.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106/115, the Internet 110, and/or the other networks 112. By way of example, the base stations 114a, 114b may be a base transceiver station (BTS), a Node-B, an eNode B, a Home Node B, a Home eNode B, a gNB, a new radio (NR) NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (for example, radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 115/116/117 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed Uplink (UL) Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using NR.

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (for example, an eNB and a gNB).

In other embodiments, the base station 114a and the WTRUs 102a, 102b, 102c may implement radio technologies such as IEEE 802.11 (i.e., Wireless Fidelity (Wi-Fi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (for example, for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (for example, WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing a NR radio technology, the CN 106/115 may also be in communication with another RAN (not shown) employing a GSM, UMTS, CDMA 2000, WiMAX, E-UTRA, or Wi-Fi radio technology.

The CN 106/115 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/113 or a different RAT.

Some or all of the WTRUs 102a, 102b, 102c, 102d in the communications system 100 may include multi-mode capabilities (for example, the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (for example, the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (for example, multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (for example, a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The source 134 may be any suitable device for powering the WTRU 102. For example, the source 134 may include one or more dry cell batteries (for example, nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (for example, longitude and latitude) regarding the current location of the WTRU 102. In addition to, or in lieu of, the information from the GPS chipset 136, the WTRU 102 may receive location information over the air interface 116 from a base station (for example, base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (for example, associated with particular subframes for both the UL (for transmission) and downlink (for reception) may be concurrent and/or simultaneous. The full duplex radio may include an interference management unit 139 to reduce and or substantially eliminate self-interference via either hardware (for example, a choke) or signal processing via a processor (for example, a separate processor (not shown) or via processor 118). In an embodiment, the WTRU 102 may include a half-duplex radio for which transmission and reception of some or all of the signals (for example, associated with particular subframes for either the UL (for transmission) or the downlink (for reception).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (or PGW) 166. While each of the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (for example, an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (for example, temporarily or permanently) wired communication interfaces with the communication network.

In representative embodiments, the other network 112 may be a WLAN. A WLAN in Infrastructure Basic Service Set (BSS) mode may have an Access Point (AP) for the BSS and one or more stations (STAs) associated with the AP. The AP may have an access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (for example, directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (for example, all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (for example, 20 MHz wide bandwidth) or a dynamically set width via signaling. The primary channel may be the operating channel of the BSS and may be used by the STAs to establish a connection with the AP. In certain representative embodiments, Carrier Sense Multiple Access with Collision Avoidance (CSMA/CA) may be implemented, for example in in 802.11 systems. For CSMA/CA, the STAs (for example, every STA), including the AP, may sense the primary channel. If the primary channel is sensed/detected and/or determined to be busy by a particular STA, the particular STA may back off. One STA (for example, only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications, such as MTC devices in a macro coverage area. MTC devices may have certain capabilities, for example, limited capabilities including support for (for example, only support for) certain and/or limited bandwidths. The MTC devices may include a battery with a battery life above a threshold (for example, to maintain a very long battery life).

WLAN systems, which may support multiple channels, and channel bandwidths, such as 802.11n, 802.11ac, 802.11af, and 802.11ah, include a channel that may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (for example, MTC type devices) that support (for example, only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation (CA) technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (for example, containing varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (for example, such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement dual connectivity (DC) principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one Session Management Function (SMF) 183a, 183b, and possibly a Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (for example, handling of different protocol data unit (PDU) sessions with different requirements), selecting a particular SMF 183a, 183b, management of the registration area, termination of NAS signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for machine type communication (MTC) access, and/or the like. The AMF 162 may provide a control plane function for switching between the RAN 113 and other RANs (not shown) that employ other radio technologies, such as LTE, LTE-A, LTE-A Pro, or non-3GPP access technologies, such as Wi-Fi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating WTRU IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (for example, an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-ab, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (for example, testing) wired and/or wireless communication network in order to implement testing of one or more components. The one or more emulation devices may be test equipment. Direct RF coupling and/or wireless communications via RF circuitry (for example, which may include one or more antennas) may be used by the emulation devices to transmit and/or receive data.

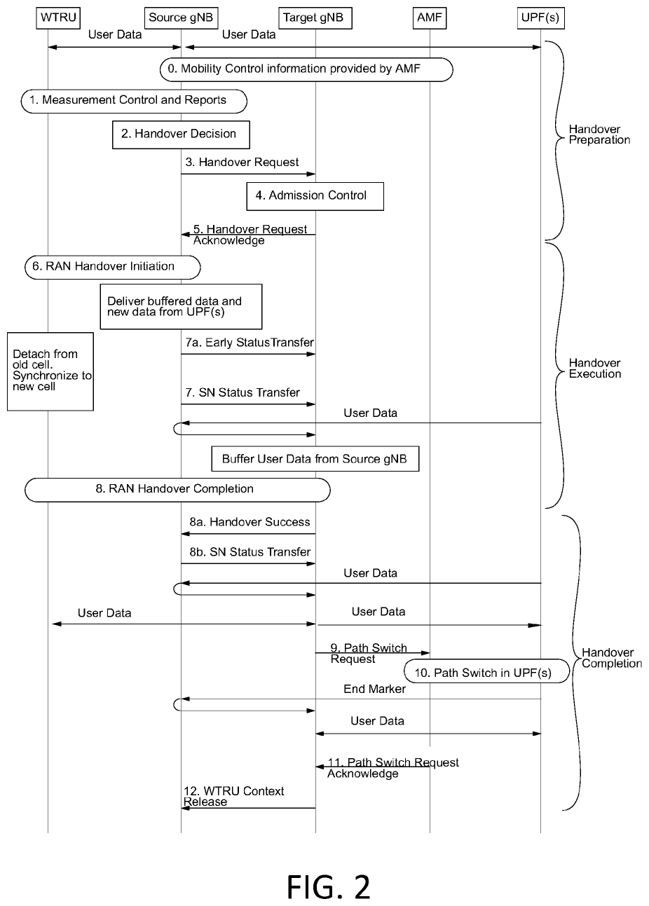

FIG. 2 depicts a handover scenario, for example, in new radio (NR). Within the initial handover preparation, the WTRU (e.g., that is within cell coverage of the source gNB) may receive information regarding roaming, access restrictions, and/or other Mobility Control information, for example, from the AMF at connection establishment and/or at the last timing advance (TA) update. The Mobility Control information may be provided to the WTRU, source gNB, and/or the target gNB by the (AMF). The source gNB may configure the WTRU measurement procedures and the WTRU may report according the measurement configuration to the source gNB. The source gNB may decide to handover the WTRU, based on the received measurements.

The source gNB may then issue a Handover Request message to the target gNB by passing a transparent radio resource control (RRC) container with information to prepare the handover at the target side. The information may comprise, at least one or more of, a target cell ID, KgNB, C-RNTI (radio link identifier) of the WTRU in the source gNB, radio resource management (RRM) configuration including WTRU inactive time, basic AS-configuration including antenna Info and DL Carrier Frequency, current QoS flow to data radio bearer (DRB) mapping rules applied to the WTRU, SIB1 from source gNB, the WTRU capabilities for different RATs, and PDU session related information, or may further include WTRU reported measurement information including beam-related information if available.

Admission Control may be performed by the target gNB. If the WTRU is admitted, the target gNB may prepare the handover with L1/L2 and send the HANDOVER REQUEST ACKNOWLEDGE to the source gNB, which may include a transparent container to be sent to the WTRU as an RRC message to perform the handover. Once the HANDOVER REQUEST ACKNOWLEDGE has been delivered, handover execution may begin, such that the WTRU may detach from the old cell and synchronize to the new cell.

The source gNB may trigger the WTRU handover by sending an RRCReconfiguration message to the WTRU, containing the information to access the target cell, such as the target cell ID, the new C-RNTI, and/or the target gNB security algorithm identifiers for the selected security algorithms. The RRCReconfiguration message may also include a set of dedicated random access channel (RACH) resources, the association between RACH resources and synchronization signal blocks (SSBs), the association between RACH resources and WTRU-specific CSI reference signal (RS) configuration(s), common RACH resources, and system information of the target cell, etc. In one application, the buffered data and new data may be delivered from the UPF(s).

As the detachment begins, the source gNB may send the early transfer status transfer data and the SN STATUS TRANSFER message to the target gNB to convey the uplink PDCP SN receiver status and the downlink PDCP SN transmitter status of DRBs for which PDCP status preservation applies (e.g., for radio link control (RLC) AM). The user data may be provided to the source gNB, by the WTRU, and then to the target gNB. The WTRU may synchronize to the target cell and complete the RRC handover procedure by sending RRCReconfiguration Complete message to target gNB.

In the Handover Completion portion of the scenario, a HO success signal may be sent from the target gNB to the source gNB. The source gNB may provide an SN Status Transfer to the target gNB. The target gNB may send a PATH SWITCH REQUEST message to AMF to trigger 5GC to switch the DL data path towards the target gNB and to establish an NG-C interface instance towards the target gNB. The 5GC may switch the DL data path towards the target gNB. The UPF may send one or more “end marker” packets on the old path to the source gNB per PDU session/tunnel and then may release any U-plane/TNL resources towards the source gNB. The AMF may confirm the PATH SWITCH REQUEST message with the PATH SWITCH REQUEST ACKNOWLEDGE message. Upon reception of the PATH SWITCH REQUEST ACKNOWLEDGE message from the AMF, the target gNB may send the WTRU CONTEXT RELEASE to inform the source gNB about the success of the handover. The source gNB may then release radio and C-plane related resources associated to the WTRU context. Any ongoing data forwarding may continue.

NR Release 16 introduced the concept of conditional handover (CHO) and conditional primary secondary serving cell (PSCell) addition/change continuous packet addition (CPA)/continuous packet change (CPC), or collectively referred to as CPAC), with the potential of reducing the likelihood of radio link failures (RLF) and handover failures (HOF).

Legacy LTE/NR handover may be typically triggered by measurement reports, even though there may be nothing preventing the network from sending an HO command to the WTRU even without receiving a measurement report. For example, the WTRU may be configured with an A3 event (neighbor becomes offset better than SpCell) that triggers a measurement report to be sent when the radio signal level/quality (reference signal received power (RSRP), reference signal received quality (RSRQ), etc.) of a neighbor cell becomes better than the primary serving cell (PCell), or also the PSCell in the case of DC. An A3 event may be triggered when a neighbor cell becomes better than a special cell (SpCell) by an offset. A special cell may be the primary serving cell of either the Master Cell Group (MCG) or Secondary Cell Group (SCG). The offset may be either positive or negative. A3 events may typically be used for intra-frequency or inter-frequency handover procedures. When an A2 event is triggered, the WTRU may be configured with measurement gaps to measure the inter frequency objects and an A3 event for inter-frequency handover. An A3 event may provide a handover triggering mechanism based upon relative measurement results. For example, the handover triggering mechanism may be configured to trigger when the RSRP of a neighbor cell is stronger than the RSRP of special cell.

The WTRU may monitor the serving and neighbor cells and may send a measurement report when conditions are fulfilled. When such a report is received by the network, the network (current serving node/cell) may prepare the HO command. This HO command may be an RRC Reconfiguration message, with a reconfiguration WithSync, that is sent to the WTRU, which the WTRU may execute resulting in the WTRU connecting to the target cell.

In some examples, multiple handover targets are prepared. Further, the WTRU may not immediately execute the CHO. The WTRU may be configured with triggering conditions, such as a set of radio conditions, and the WTRU may execute the handover towards one of the targets if the triggering conditions are fulfilled.

The CHO command may be sent from the network when the radio conditions towards the current serving cells are still favorable, thereby reducing, among other things, the risk of failing to send the measurement report (for example, if the link quality to the current serving cell falls below acceptable levels when the measurement reports are triggered in normal handover) and the failure to receive the handover command (for example, if the link quality to the current serving cell falls below acceptable levels after the WTRU has sent the measurement report, but before it has received the HO command). The WTRU may send the CHO command when the radio conditions towards the current serving cells begin to get worse (e.g., deteriorate).

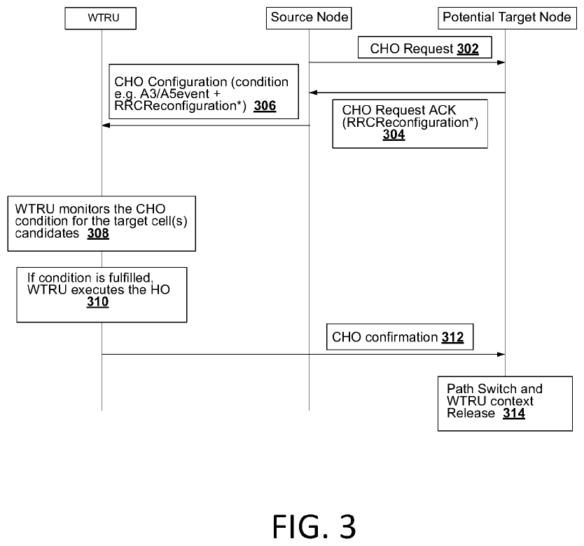

FIG. 3 shows a conditional handover configuration and execution. At 302, the source node may send the CHO request 302 to the potential target node. At 304, the potential target node may send a CHO Request ACK, comprising a RRCReconfiguration, to the source node. At 306, the WTRU may implement the CHO configuration. The source node may send the RRCReconfiguration to the WTRU, which the WTRU receives. The triggering conditions for a CHO may be based on the radio quality of the serving cells and neighbor cells, for example, the conditions that are used in legacy LTE/NR to trigger measurement reports. Further, the WTRU may be configured with a CHO that has A1 (e.g., serving cell becomes better than threshold), A2 (e.g., serving cell becomes worse than threshold), A3 (e.g., neighbor becomes offset better than SpCell), A4 (e.g., neighbor becomes better than threshold), A5 (e.g., SpCell becomes worse than threshold1 and neighbor becomes better than threshold2), A6 (e.g., neighbor becomes offset better than SCell), B1 (e.g., inter RAT neighbor becomes better than threshold), and/or B2 (e.g., PCell becomes worse than threshold1 and inter RAT neighbor becomes better than threshold2) triggering conditions and an associated HO command. An A5 event may be triggered when a special cell becomes worse than threshold 1, while a neighboring cell becomes better than threshold 2. A5 events may be is used for intra-frequency or inter-frequency handover procedures. After an A2 event is triggered, the WTRU may be configured with measurement gaps and an A5 event for inter-frequency handover. A5 events may provide a handover triggering mechanism based upon absolute measurement results. A5 events may be used to trigger a time critical handover when a current special cell becomes weak and it is necessary to change towards another cell which may not satisfy the criteria for an A3 event handover. At 308, the WTRU may monitor the CHO conditions for the current cells, serving cells, and/or target cell candidates. At 310, when the A3 triggering conditions are fulfilled, the WTRU may, instead of sending a measurement report, execute the associated HO command and switch its connection towards the target cell. At 312, the WTRU may send CHO confirmation to the target node. And at 314, the Path Switch may be executed by the target node and the WTRU context release may be executed by the source node (see for example, 10. -12. of FIG. 2).

The CHO may help prevent unnecessary re-establishments in case of a radio link failure. For example, the WTRU may be configured with multiple CHO targets and the WTRU may experience an RLF before the triggering conditions with any of the targets get fulfilled. Legacy operation may have resulted in RRC re-establishment procedure that may also have incurred considerable interruption time for the bearers of the WTRU. However, in the case of CHO, if the WTRU, after detecting an RLF, ends up in a cell for which it has a CHO associated (e.g., the target cell may be already prepared for it), the WTRU may execute the HO command associated with this target cell directly, instead of continuing with the full re-establishment procedure.

CPC and CPA may be extensions of CHO in DC scenarios. In embodiments, a WTRU may be configured with triggering conditions for PSCell change or addition, and when the triggering conditions are fulfilled, it may execute the associated PSCell change or PSCell add commands.

Within NR Release 17, inter-cell L1/L2 mobility may manage the beams in CA case, without cell change/add supported. In Release 18, one of the contemplated objectives is to specify mechanisms and procedures of L1/L2 based inter-cell mobility for mobility latency reduction. In embodiments, mechanism and procedures of L1/L2 based inter-cell mobility for mobility latency reduction may be specified. Configuration and maintenance for multiple candidate cells may be specified to allow fast application of configurations for candidate cells [RAN2, RAN3]. Dynamic switch mechanism among candidate serving cells (including special cell (SpCell) and/or SCell) for the potential applicable scenarios based on L1/L2 signaling [RAN2, RAN1] may also be provided. SpCell may refer to the PCell of the MSG and/or the PSCell of the secondary cell group (SCG) depending on whether the MAC entity is associated to the master cell group (MCG) or the SCG. The WTRU may be configured to receive a plurality of measurement configurations accompanied by an association with one or more special cell (SpCell)/secondary cell (SCell) combinations. L1 enhancements may be provided for inter-cell beam management, including L1 measurement and reporting, and beam indication [RAN1, RAN2]. Early RAN2 involvement may be used, including the possibility of further clarifying the interaction with dynamic switching. Timing Advance management [RAN1, RAN2] and CU-DU interface signaling to support L1/L2 mobility, if desired [RAN3], may also be provided. FR2 specific enhancements may not precluded. Further, the procedure of L1/L2 based inter-cell mobility are applicable to various scenarios, such as standalone, CA and NR-DC case with serving cell change within one configured grant or cell group (CG), intra-DU case and intra-CU inter-DU case (applicable for Standalone and CA when no new RAN interfaces are expected), intra-frequency, inter-frequency, FR1, FR2, source and target cells being synchronized or non-synchronized, and inter-CU case not included.

L1/L2 based mobility was originally started in NR Release 17 and inter-cell beam management in Release 17 addresses intra-DU and intra-frequency scenarios. In this case the serving cell remains unchanged (e.g. with no possibility to change the serving cell using L1/L2 based mobility). In FR2 deployments, CA is typically used in order to exploit the available bandwidth, for example, to aggregate multiple CCs in one band. These CCs are typically transmitted with the same analog beam pair (gNB beam and WTRU beam). The WTRU may be configured with TCI states (may have fairly large number, for example, 64) for reception of physical downlink control channel (PDCCH) and physical downlink shared channel (PDSCH). Each TCI state may include a RS or SSB that the WTRU refers to for setting its beam. For Release 17, the SSB may be associated with a non-serving PCI. MAC signaling (“TCI state indication for WTRU-specific PDCCH MAC control Element (CE)”) may activate the TCI state for a Coreset/PDCCH. Reception of PDCCH from a non-serving cell may be supported by MAC CE indicating a TCI state associated to non-serving PCI. MAC signaling (“TCI States Activation/Deactivation for WTRU-specific PDSCH”) may activate a subset of (up to) 8 TCI states for PDSCH reception. Downlink control information (DCI) may indicate which of the 8 TCI states. Release 17 also supports “unified TCI state” with a different updating mechanism (DCI-based), but without multi-transmission/reception point (TRP). Release 18 may support unified TCI state with multi-TRP.

With a conventional level 3 (L3), handover may be conditioned on the WTRU first sending a measurement report using RRC signalling. In response, the network may provide a further measurement configuration and potentially a CHO configuration. With a CHO the network provides a configuration for a target cell after the WTRU reports using RRC signalling that the cell meets a configured radio quality criteria. With conditional handover, in order to reduce the handover failure rate due to the delay in sending a measurement report then receiving an RRC reconfiguration, the network may provide in advance a target cell configuration as well as measurement criteria that determines when the WTRU may trigger the CHO configuration. These L3 methods may result in some amount of delay due to the sending of measurement reports and receiving of target configurations, particularly in the case of the conventional (non-conditional) handover.

In embodiments, L1/L2 inter-cell mobility may be used to improve handover latency. Further, the L1/L2 based inter-cell mobility may allow a fast application of configurations for candidate cells, including dynamically switching between SCells and switching of the PCell (for example, switching the roles between SCell and PCell) without performing RRC signalling. The inter-CU case is not included in Release 18, as this comprises relocation of the PDCP anchor and has already been excluded from the WI. An RRC based approach may be desired, such as to support inter-CU handover. One of the aims of L1/L2 should also be to allow CA operation to be enabled instantaneously upon serving cell change.

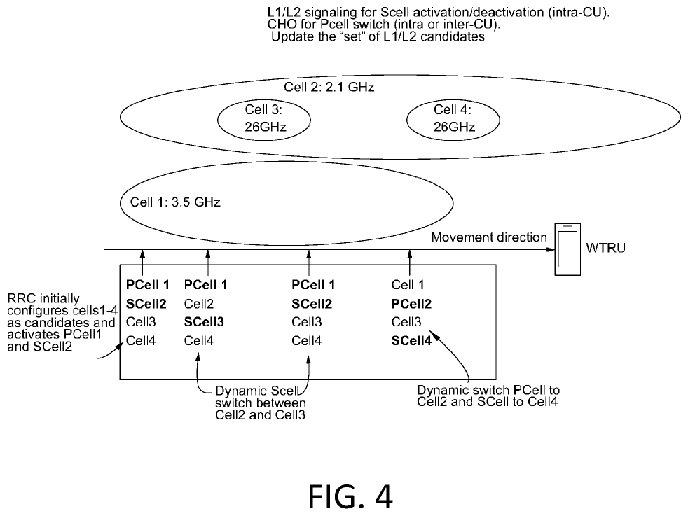

FIG. 4 shows an example of L1/L2 inter-cell mobility operation using carrier aggregation (CA), whereby the candidate cell group is configured by RRC and a dynamic switch of PCell and SCell may be achieved using L1/L2 signalling. The WTRU may be configured via RRC with cells 1-4 as candidate cells and activate PCell1 and SCell2. The WTRU may receive configuration information indicating a plurality of mobility candidate cells and a plurality of measurement configurations. The base station may execute L1/L2 signaling for Scell activation/deactivation (intra-CU). CHO for Pcell switch (intra or inter-CU) may take place, and the “set” of L1/L2 candidates may be updated. The WTRU may activate a first measurement configuration of a plurality of measurement configurations based on a first cell being a current serving cell for the WTRU. The WTRU may also determine that a second measurement configuration of the plurality of measurement configurations is deactivated based on the first cell being a current serving cell for the WTRU.

As the WTRU performs mobility from left to right, the WTRU may switch (e.g., switch dynamically) the Scell between Cell2 and Cell3. The higher frequency and higher bandwidth of Cell3 and Cell4 may be a factor in the determination (or conditions) for switching to a target cell. The WTRU may receive Layer 1 or Layer 2 (L1/L2) control signaling indicating that the WTRU is to perform mobility to a second cell, the second cell being one of the plurality of mobility candidate cells. As the WTRU continues to perform mobility to the right, the WTRU may switch (e.g., switch dynamically) the PCell to Cell2 and switch (e.g., dynamically switch) the SCell to Cell4. The WTRU may determine which of the plurality of measurement configurations are to be activated and which of the plurality of measurement configurations are not to be activated upon performing mobility to the second cell (e.g., the second cell being a primary cell) based on the second cell being a new serving cell for the WTRU and the mobility to the second cell causing an activation of a third cell of the plurality of mobility candidate cells as a secondary cell. The second measurement configuration may also be determined to be activated. The WTRU may be configured to determine which of a plurality of measurement configurations are to be activated and which of the plurality of measurement configurations are not to be activated upon performing mobility to the second cell (e.g., PCell 1 to PCell 2) based on the one or more SpCell/SCell combinations. The WTRU may also be configured to determine which of the plurality of measurement configurations are to be activated and which of the plurality of measurement configurations are not to be activated upon performing mobility to the second cell based on a combination of currently active secondary cells (SCells) in the plurality of mobility candidate cells.

As discussed herein, Release 18 does not introduce support for inter-CU handover using L1/L2 signaling. Therefore, a conventional or conditional handover may be employed to cover at least this case. A conventional or conditional handover may be employed to support any mobility from with any specific L1/L2 mobility area to another.

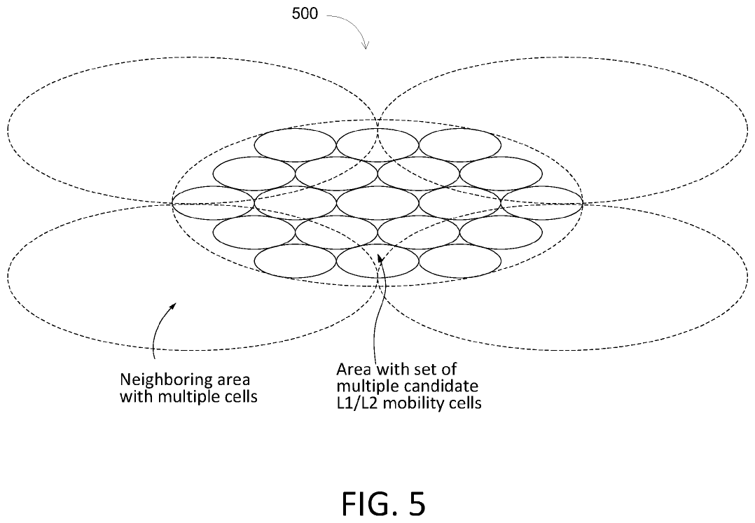

FIG. 5 shows an example of an L1/L2 mobility area 500. L1/L2 inter-cell mobility may be deployed in certain areas. The network may define an area with a set of multiple candidate L1/L2 mobility cells. Further, the network may divide its deployment into multiple L1/L2 mobility areas for other reasons, such as cell planning or due to limitation on the maximum number of cell configurations that may be simultaneously stored in the WTRU. The network may define a neighboring area with multiple cells (e.g., cells that are not candidate L1/L2 mobility cells).

Since L1/L2 inter-cell mobility may be intended to cover a much larger geographical area without any RRC reconfiguration signaling than conventional handover (e.g., the WTRU may move between more than one PCell without RRC Reconfiguration) this may have a knock-on effect in terms of the amount of RRC configuration used to enable the WTRU to move around the L1/L2 mobility area, in order to support mobility outside of the area. With the conventional L3 mobility, the network may typically provide measurement configurations and conditional handover configurations based on the PCell currently serving the WTRU, and the potential target cells that are neighbors to the serving PCell. If a PCell change occurs, either due to handover or conditional handover, then the measurement configurations may be updated by RRC signaling, and new CHO configurations are potentially provided.

If the serving cells may be dynamically switched using L1/L2 signaling, but the measurement configurations and conditional handover configurations still are to be updated using RRC signaling, this may limit the effectiveness of the dynamic switch mechanism, as the delay employed to perform the RRC signaling may be significant.

In embodiments, it may be possible to pre-configure many measurement and conditional handover configurations, such that the WTRU may be equipped to perform the measurements and handover to cells outside of the configured L1/L2 mobility area; for example, for the case the WTRU moves into the coverage of another CU. However, there may be a limitation to the number of CHO configurations and measurement objects that may be configured simultaneously in the WTRU. This may be in part due to limiting the complexity of the WTRU (in terms of the number of parallel measurements and conditions to evaluate) but may also be designed to limit the amount of resources that the network reserves for any given WTRU—in case of conditional handover, the network may reserve resources on the target cell(s) in anticipation of the WTRU meeting the condition and performing a CHO. If the network desires to configure many CHOs, this also implies the number of resources (in potential target cells) that may have to be reserved in the network may become unacceptably large.

In Release 18 there are contemplated enhancements to CPAC targeted in the WI identified above. Mechanisms and procedures of NR-DC are specified with selective activation of the cell groups for, as an example, SCG via L3 enhancements. Further, it is contemplated to allow subsequent cell group change after changing CG without reconfiguration and re-initiation of CPC/CPA (RAN2, RAN3, RAN4). It is possible that a harmonized RRC modelling approach may be considered to minimize the workload in RAN2.

The intention of this Release 18 WI objective appears to be to allow for CPC/CPA configurations to be active after the CPC/CPA has been triggered. Currently, when the reconfiguration is triggered, the WTRU may release any currently configured CPA/CPC configurations and the network may set up new CPA/CPC configurations. This may also be the case for CHO. Release 18 implies CPA/CPC are addressed but not CHO/MGC. However, it is contemplated that similar issues may exist for CHO.

The WTRU may be configured with a set of multiple candidate target cells, which may be activated dynamically using L1 and/or L2 signaling, as shown in FIG. 4. The configurations within the set of possibilities, for example the active PCell or the PCell/SCell combinations, may be associated with one or more measurement reporting configurations for legacy measurement reporting or for CHO. Some of these measurement/CHO configurations may be stored but not active, until the associated cell configuration may be dynamically activated using L1/L2 signaling. Similarly, in the case of CHO, the network may not need to reserve resources on the target cell(s) until the time that it activates a specific cell combination (or combination of other parameters). This allows the WTRU to store the measurement and CHO configurations it will use throughout the area of potential L1/L2 mobility cells, and activate those configurations when it is in the appropriate area.

As generally discussed herein, “measurements”, unless otherwise specified, refers to measurements object and associated reporting configuration as in legacy NR (e.g., when reporting conditions are fulfilled, a measurement report may be sent). Further, “CHO configuration”, unless otherwise specified, generally refers to measurement objects and associated reporting configuration for CHO (e.g., when reporting conditions are fulfilled, the associated CHO may be executed). However, certain measurement objects may be associated with multiple reporting configurations (be it for legacy measurement report triggering or for CHO).

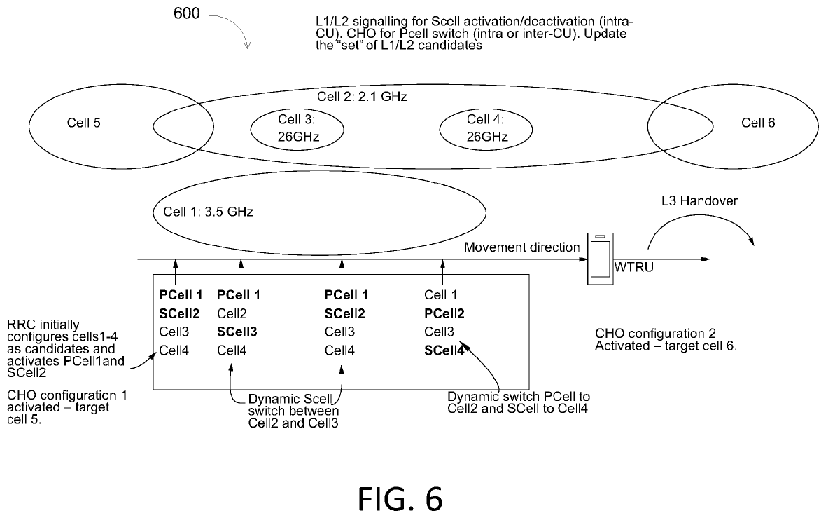

FIG. 6 shows an example of dynamic activation of a conditional handover (CHO) configuration 600. In the example of FIG. 6 L1/L2, signalling for Scell activation/deactivation (intra-CU), CHO for Pcell switch (e.g., intra or inter-CU), and updating the “set” of L1/L2 candidates may be executed. In this example, the network may provide four cell configurations. In this example, the set of candidate L1/L2 mobility cells (e.g., cells 1-4) may be configured by RRC signalling. For example, the WTRU may receive the four cell configurations indicating cells 1-4 as a plurality of mobility candidate cells and a plurality of measurement configurations. The WTRU may receive the plurality of measurement configurations (e.g., for cells 1-4) via the RRC signalling. The WTRU may activate a first measurement configuration (e.g., Cell 1 activated as PCell and Cell 2 activated as SCell) of a plurality of measurement configurations based on a first cell (e.g., Cell 1) being a current serving cell for the WTRU. In some cases, a “serving cell” may denote the primary cell and “serving cells” may denote the primary cell and the secondary cell. In certain cases, “serving cell” may refer to the secondary cell. In other cases, “serving cells” may be used to denote the set of one or more cells comprising of the primary cell and all secondary cells. In some cases, “primary serving cell” may comprise the primary cell and the “secondary serving cell” may comprise the secondary cell. In FIG. 6, the WTRU is using cell 1 as the current serving cell.

The WTRU may be configured to determine that a second measurement configuration of the plurality of measurement configurations is deactivated based on the first cell being a current serving cell for the WTRU. For example, cell 6 may be deactivated based on cell 1 being the current serving cell. Cell 6's deactivation may occur for many reasons. For example, the distance between Cell 1 and Cell 6 may be too large for Cell 1 and Cell 6 to be activated at the same time. That is, it may not be as efficient for Cell 1 to be the PCell and Cell 6 to be the SCell because Cell 6 may not serve as a good secondary cell due to its distance from Cell 1. As an example, a secondary cell may comprise a cell, operating on a primary or secondary frequency, which may be configured once an RRC connection is established, and which may be used to provide additional radio resources to the WTRU. It may be difficult to provide additional radio resources for a WTRU that is located too far away from a cell.

In FIG. 6, L1 (e.g., DCI, activating unified TCI state) or L2 (e.g., MAC CE) signalling may be used to dynamically switch the roles of these four pre-configured cells. The WTRU may receive Layer 1 or Layer 2 (L1/L2) control signalling indicating that the WTRU is to perform mobility to a second cell, the second cell being one of the plurality of mobility candidate cells. “Cell”, for example, may refer to a PCell, SCell, mobility candidate cell, activated cell, deactivated cell, first cell, second cell, third cell, fourth cell, fifth cell, nth cell or any other cell. The WTRU performing mobility may comprise the WTRU moving in a certain direction. The WTRU performing mobility may comprise projections, estimations, measurements, and/or calculations regarding a speed, direction, acceleration, and/or one or more locations regarding the WTRU. For example, if the WTRU is moving right, the WTRU, Layer 1, Layer 2, and/or Layer 3 may project where the WTRU will be located in a given amount of time and activate the desired measurement configurations and deactivate the undesirable measurement configurations. The location of the WTRU within a cell (e.g., the region of the cell that the WTRU is in) may also be used to determine which measurement configurations are activated and deactivated. For example, in FIG. 6, when WTRU is on the far-left side of Cell 1, the measurement configurations related to Cell 4 may be deactivated because Cell 4 is toward the far-right side of Cell 1. When WTRU is in the middle of Cell 1, measurement configurations related to Cell 3 may be activated because Cell 3 is right above (e.g., proximal) to the center of Cell 1.

The WTRU may determine which of the plurality of measurement configurations are to be activated and which of the plurality of measurement configurations are not to be activated upon performing mobility to the second cell based on the second cell being a new serving cell for the WTRU and the mobility to the second cell causing an activation of a third cell of the plurality of mobility candidate cells as a secondary cell, the second cell being a primary cell, wherein the second measurement configuration is determined to be activated. For example, in FIG. 6, the WTRU performs mobility from PCell 1 to PCell 2, which causes an activation of Cell 4 as the secondary cell (SCell4), wherein the secondary cell was previously Cell 2). Radio resource control (RRC) may be the highest layer in the control plane of the access stratum (AS). RRC may transfer messages of the non-access stratum (NAS), which is located above the RRC layer. In addition, in an embodiment, the network may provide one or more (in this example, 2) conditional handover configurations with target cells. The WTRU may be configured to determine which of the plurality of measurement configurations are to be activated and which of the plurality of measurement configurations are not to be activated upon performing mobility to the second cell based on a combination of currently active secondary cells (SCells) in the plurality of mobility candidate cells.

In the 3GPP standard up to Release 17, when multiple conditional handover configurations are provided, the WTRU stores these and evaluates the trigger conditions in parallel. With the proposed method, these CHO configurations may not become active immediately upon configuration (for example, a flag included in the measurement/CHO configuration that the concerned configuration may be stored) and may be activated in one or more ways, such as using explicit L1/L2 signalling indicating to activate the CHO or measurement configuration. Further activation examples may include when a certain cell becomes the PCell, when a certain SCell (e.g., or set of SCells) gets activated, when a certain SCell (e.g., or set of SCells) gets deactivated, when a certain PCell/SCell combination becomes active or is deactivated, and upon certain changes of combination (e.g., Pcell1->PCell2 change activates the configuration, but PCell3->PCell2 change may not).

In embodiments, similar mechanisms may be employed to deactivate an active CHO or measurement configuration. Other mechanisms may be employed to release/delete an active or inactive CHO or measurement configuration.

The embodiments may be used, for example, in the case of L3 handover. In embodiments, a CHO or CPAC configuration may be provided but not activated until a certain SpCell and/or one or more Scells become active, regardless whether L1/L2 triggered mobility is used. In embodiments, the WTRU may execute a CPC based configuration on an active configuration for the current serving cells. In embodiments, the WTRU may activate and begin to evaluate a stored CPC configuration that is, for example, associated with the new serving cells. In embodiments, procedures relating to a cell change that is activated or triggered using an explicit L1/L2 command may also apply to cell changes using a L3 RRC Reconfiguration or a CHO, CPC or CPA. In certain cases, a WTRU may determine that a second measurement configuration of the plurality of measurement configurations is deactivated based on the first cell being a current serving cell for the WTRU.

CHO configuration 1 may be provided with a target cell 5 and a measurement event to trigger the CHO such as CondEvent A3 (e.g., Neighbor becomes offset better than SpCell) or CondEvent A5 (e.g., SpCell becomes worse than threshold1 and neighbour becomes better than threshold2). The network may not know which direction the WTRU will move it, so the network may set up targets in more than more directions around the WTRU (e.g., left, right, forward, backward, up, down). For this reason, although the WTRU eventually moves to the right in FIG. 6, cell 5 (located on the top-left side) is a target cell. The WTRU may be configured to activate CHO configuration 1 based on Cell 1 being the PCell. As the WTRU performs mobility from left to right, the WTRU may switch (e.g., dynamically switch) the Scell between Cell2 and Cell3. As the WTRU continues to move right, the WTRU may switch (e.g., dynamically switch) the PCell m Cell1 to Cell2, and switch (e.g., dynamically switch) the SCell from Cell2 to Cell4.

The WTRU may perform one or more measurements associated with a second measurement configuration. For example, in FIG. 6, CHO configuration 2 may be provided with target cell 6 and a measurement event to trigger the CHO, similar to CHO configuration 1. CHO configuration 2 may also be activated based on Cell 2 being the PCell (e.g., or alternatively the combination of PCell 1 and SCell 4 activates CHO configuration 2). Rather than evaluating all of the configured CHOs in parallel, the WTRU may evaluate the CHO(s) according to the associated combination of active cells. This may reduce the processing overhead in the WTRU, such that the relevant measurements and evaluation may be performed depending on the WTRU location within the L1/L2 mobility area. This also may reduce the resource usage in the network. The network may not need to reserve resources on all configured target CHO cells, but rather may reserve resources according to the activated CHO configuration, for example, since the network may be in control (e.g., using L1/L2 signalling) of the combination of active cells used by the WTRU, the network also has control of what the target CHO cells and the currently active CHO configurations in the WTRU are. The same or similar method may also be used to control measurement objects and measurement reporting for conventional handover. The WTRU may send a measurement report via a second cell based on the measurements associated with the second measurement configuration. For instance, instead of or in addition to one or more CHO configurations, one or more measurement objects may be configured for measurement reporting and associated to one or more L1/L2 controlled cell combinations. Additionally, the carriers and/or the cells (e.g., neighbour carriers and cells) that are currently measured by the WTRU may be associated with the L1/L2 controlled cell combinations.

Activating Measurement Configurations and/or Conditional Reconfiguration(s) may be based on any “conditions” representing where the WTRU may be located within the L1/L2 mobility area or within an area corresponding to a set of cells with preconfigured measurements or CHO/CPAC. The conditions may include which PCell and/or SCell(s) are activated, and may include cases where there may be no active SCell and/or SCell might be de-activated for power saving reasons.

A “mobility area index” may be introduced and configured in each instance of “X” and “Y” with at least one “mobility area index”. In the embodiment, “X” may include anything that may be activated/deactivated as a function of the location of the WTRU, for example: TCI state, non-serving PCI (e.g., within “NumberOfAdditionalPCI”), PCell/SCell combinations, active bandwidth part (BWP), SCell activation state, a measurement event trigger condition being met, a DL synchronisation trigger to a candidate cell, a PDCCH ordered RA towards a candidate cell, and/or enabling of radio link monitoring (RLM) or beam failure detection (BFD) of a target cell. In some examples, the non-serving PCI may be activated if a TCI state associated with the PCI is activated.

“Y” may include anything that supports measurements/mobility, for example, a configured measurement configuration, a configured conditional reconfiguration and/or channel state information (CSI) reporting configuration, a BFR configuration, and/or neighbour carrier/cell list. A configured measurement configuration may include a L3 measurement object, a L1 or L3 measurement event, a CSI measurement configuration, and/or a L1 or L3 measurement RS configuration (e.g., SSB or CSI-RS resource for a current or neighbor cell). A configured measurement configuration may include a PCI or logical ID, SMTC location, frequency location, and/or SCS.

Based on the above, it is contemplated that the examples of the possible behaviours may, for example, include if “X” is activated, then any “Y” with same “mobility area index” configured for X is also activated. In some examples, Y may be deactivated if there is no activated “X” with same “mobility area index”. In some examples, an explicit activation/deactivation or switching of “mobility area index” may occur, which may activate/deactivate a corresponding X and/or Y.

One example of a “mobility area index” could be one or more indexes or identifiers associating “X” (e.g., anything that could be activated/deactivated as a function of the location of the WTRU) with “Y” (e.g., anything that supports measurements/mobility). For example, the WTRU may be configured with one or more measurement configurations which each have an index. The WTRU may additionally be configured with one or more conditions (e.g., SpCell/SCell combinations) and/or a list of one or more indexes identifying the measurement configurations to enable when the one or more conditions are satisfied. Each of the configured conditions may be associated with the same or a different subset of measurement configurations. In this way, a measurement configuration may not need to be repeated for every possible SpCell/SCell combination, but each of the combinations for which the measurement configuration is applicable (e.g., an SpCell/Scell combination configured as a L1/L2 mobility candidate configuration) can reference the measurement configuration (e.g., configured in an independent list or structure from L1/L2 mobility candidate configurations) using the index or identifier. In addition, this allows a larger number of measurements to be configured (e.g., by RRC) than will be applicable for any given SpCell/SCell combination (e.g., activated or triggered by MAC CE).

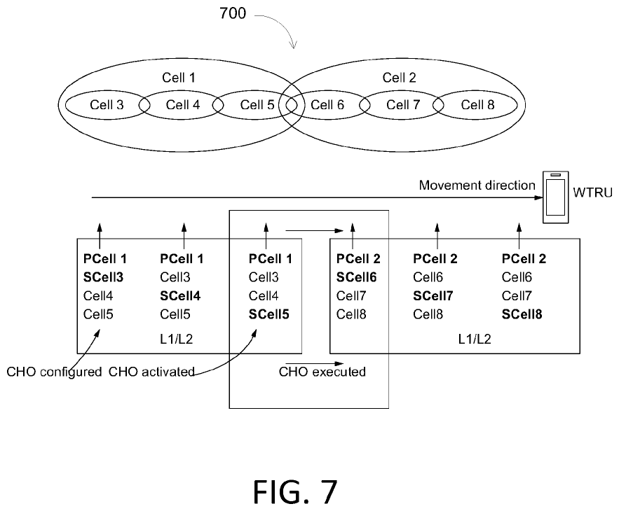

FIG. 7 shows an example of dynamic activation of a CHO configuration 700. In this example, the first set of L1/L2 mobility candidate cells consists of cells 1, 2, 3, 4 and the second set of L1/L2 mobility candidate cells consists of cells 5, 6, 7, 8. At 704, one or more CHO configurations may be configured, but for the purpose of this illustration, one configuration is shown. The CHO configuration includes a target PCell configuration, but may also include a target PCell and SCell configuration (e,g., PCell 1 and SCell 3). The CHO configuration may also include a target set of L1/L2 mobility candidate cells, that is, the set of L1/L2 mobility candidate cells that may be dynamically controlled using L1/L2 signalling after successful completion of the CHO. In some cases, the L1/L2 control signaling may comprise a medium access control (MAC) control element (CE). The L1/L2 control signaling may indicate a new special cell (SpCell) and an activated secondary cell (Scell). RRC and NAS messages functions may be used to exchange the signalings between the WTRU and gNB, CE may be a special MAC structure that carries special control information. MAC CE may work between UE (MAC) and gNB (MAC) for FAST Signaling Communication Exchange without involving upper layers. The WTRU may activate a first measurement configuration (e.g., PCell 1, SCell 3) of a plurality of measurement configurations based on a first cell being a current serving cell for the WTRU. The WTRU may also determine that a second measurement configuration of the plurality of measurement configurations is deactivated (e.g., measurement configurations related to Cells 2, 4-8) based on the first cell being a current serving cell for the WTRU.

At 706, the CHO trigger may use one of the existing measurement events such as Event A3 or Event A5. The CHO may alternatively utilize one or more new measurement events. The CHO evaluation may be triggered (or activated) when Cell 5 becomes the SCell, implying that the WTRU may be reaching the border between cells 1 and 2 and should therefore start to evaluate the conditions for handover to target cell 2. In some examples, the CHO trigger itself may be the activation of a particular combination of cells (in this example activation of SCell 5) or the activation of any condition related to the mobility area as explained earlier. At 708, the CHO may be executed and the PCell1 may dynamically switch to PCell2, and SCell5 may dynamically switch to SCell6. As the WTRU continues to perform mobility to the right, dynamic switching may continue to take place for the secondary cells (e.g., Cell7 then Cell8) and the primary cells.

In embodiments, the criteria for activation or deactivation of a measurement or CHO configuration may be related to specific transitions rather than the static configuration. For example, a change of SCell from Cell 3 to cell 5 may not trigger a certain configuration, but a change of SCell from cell 4 to cell 5 may activate this. Therefore, the activation takes into account the current cell configuration and a previous cell configuration. The WTRU may determine which of the plurality of measurement configurations are to be activated and which of the plurality of measurement configurations are not to be activated upon performing mobility to the second cell based on the second cell being a new serving cell for the WTRU and the mobility to the second cell causing an activation of a third cell of the plurality of mobility candidate cells as a secondary cell, the second cell being a primary cell, wherein the second measurement configuration is determined to be activated.

In embodiments, WTRU may send an indication to the network whenever the activation status of a CHO or measurement configuration changes (for example, when the configuration gets activated, when the configuration gets deactivated, when the configuration gets released). In some cases, measurement configurations may comprise channel state information (CSI) reporting configurations.

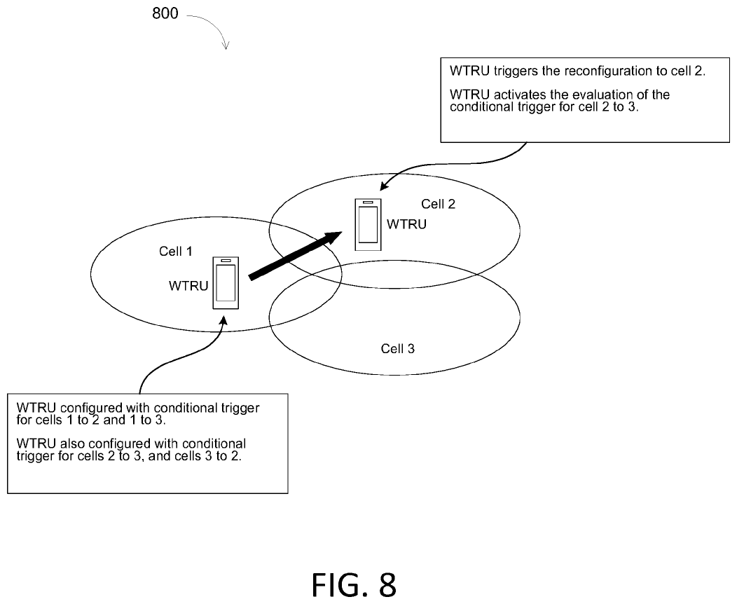

FIG. 8 shows an example diagram 800 of the activation of a CHO/CPAC configuration depending on the current SpCell. As shown in FIG. 8, a WTRU may be configured with multiple CHO (e.g., or CPC) target cells, based on one or more measurement events. Upon execution of the CHO (e.g., or CPC) towards a new SpCell, the WTRU may start to evaluate the stored CHO (e.g., or CPC) configurations which apply potentially to the same target cells or may be applied towards different target cells. The WTRU may be configured to receive a plurality of measurement configurations accompanied by an association with one or more special cell (SpCell)/secondary cell (SCell) combinations. The WTRU may be configured to determine which of the plurality of measurement configurations are to be activated and which of the plurality of measurement configurations are not to be activated upon performing mobility to the second cell based on the one or more SpCell/SCell combinations and/or based on a combination of currently active secondary cells (SCells) in the plurality of mobility candidate cells.

The WTRU may be configured with conditional trigger for cells 1 to 2 and 1 to 3. The WTRU may also configured with conditional trigger for cells 2 to 3, and cells 3 to 2. The WTRU may receive configuration information indicating a plurality of mobility candidate cells and a plurality of measurement configurations. The WTRU may be configured, by the network, with two conditional triggers with a target of cell 2, for example, such as one that is used while on cell 1 and another that is used while on cell 3. Similarly, the WTRU may be configured with two conditional triggers with a target of cell 3, such as one that is used while on cell 1 and another that is used while on cell 2.

The WTRU may be configured with a conditional trigger for moving to cell 2, with a different offset depending whether the WTRU is currently on cell 1 or 3. Similarly, the conditional trigger for moving to cell 3 may be configured, by the network, with a different offset depending on whether the WTRU is currently on cell 1 or 2.

The WTRU may trigger the reconfiguration to cell 2. The WTRU may activate the evaluation of the conditional trigger for performing mobility from cell 2 to 3 and/or cell 2 to cell 1. The WTRU may activate a first measurement configuration of a plurality of measurement configurations based on a first cell being a current serving cell for the WTRU. The WTRU may determine that a second measurement configuration of the plurality of measurement configurations is deactivated based on the first cell being a current serving cell for the WTRU.

The CHO or CPC configurations may be independent, for example, based on the current RRC signalling structure. In some examples, the conditional trigger configuration may be as follows:

| | |
|---|---|
| CondTriggerConfig-r16 ::= | SEQUENCE { |
| condEventId | CHOICE { |
| condEventA3 | SEQUENCE { |
| a3-Offset | MeasTriggerQuantityOffset, |
| hysteresis | Hysteresis, |
| timeToTrigger | TimeToTrigger |

},

| | |
|---|---|
| condEventA5 | SEQUENCE { |
| a5-Threshold1 | MeasTriggerQuantity, |
| a5-Threshold2 | MeasTriggerQuantity, |
| hysteresis | Hysteresis, |
| timeToTrigger | TimeToTrigger |

```
    },
    ...,
```

| | |
|---|---|
| condEventA4-r17 | SEQUENCE { |
| a4-Threshold-r17 | MeasTriggerQuantity, |
| hysteresis-r17 | Hysteresis, |
| timeToTrigger-r17 | TimeToTrigger |
| }, | |
| condEventD1-r17 | SEQUENCE { |

```
      distanceThreshFromReference1-r17 INTEGER(0.. 65525),
      distanceThreshFromReference2-r17 INTEGER(0.. 65525),
```

| | |
|---|---|
| referenceLocation1-r17 | ReferenceLocation-r17, |
| referenceLocation2-r17 | ReferenceLocation-r17, |
| hysteresis-r17 | HysteresisLocation-r17, |
| timeToTrigger-r17 | TimeToTrigger |

},

| | |
|---|---|
| condEventT1-r17 | SEQUENCE { |
| t1-Threshold-r17 | INTEGER (0..549755813887), |
| duration-r17 | INTEGER (1..6000) |

```
    }
  },
```

| | |
|---|---|
| rsType-r16 | NR-RS-Type, |

...
}

In the embodiment above, each CHO/CPAC configuration is (preferably) provided with the event type and the offset/threshold/hysteresis/time, to trigger parameters as appropriate. Where triggering one active CHO or CPAC to a new SpCell, the WTRU may activate new conditional trigger configurations for CHO, CPA or CPC associated with the new SpCell.

It may be desired to re-use the same conditional trigger configuration for multiple cells and provide parameters which may be different. A conditional trigger (for CHO, CPC, CPA) may be provided for a particular target cell, for example conditional event A3. All of the configuration may be identical for the target cell, regardless of the current cell, except for the offset to be used. The WTRU may then receive a conditional trigger configuration for a particular cell, and further receive a list of offsets to use that are dependent on the currently SpCell.

In some embodiments, the WTRU may set initial conditions for the applied measurement configurations using a first condition, with details on how to further update the configurations using a second condition.

In some embodiments, the WTRU may determine a first configuration based on a first condition (e.g., the new SpCell/SCell combinations), and may subsequently update the configuration based on a second condition (e.g., the SCell activation/deactivation state). For example, the WTRU may be configured to perform a L1/L2 triggered handover and apply a configuration using cell 1 as PCell, and Cells 2 and/or 3 as SCells. Cells 2, 3 may additionally be configured as L1/L2 handover target cells (e.g., target SpCell provided in a L1/L2 handover candidate configuration). The initial state of the SCells may be deactivated. Based on this, the WTRU may apply a first measurement configuration associated with measurements and/or reporting of cells 2 and 3 based on the cells being L1/L2 handover target cells. The WTRU may subsequently receive an indication to activate one or both of cells 2 and 3. The WTRU may then apply a measurement configuration associated with reporting active SCells. For example, the WTRU may be configured with one type of measurement resource (e.g., an SSB measurement resource configuration) and/or the WTRU may be configured to perform reporting using a first type of reporting (e.g., CSI reporting containing information specific to L1/L2 handover preparation) to use when the cell is configured as an SCell but is not active. In some cases, the WTRU may receive Layer 1 or Layer 2 (L1/L2) control signaling indicating that the WTRU is to perform mobility to a second cell, the second cell being one of the plurality of mobility candidate cells. The WTRU may also determine which of the plurality of measurement configurations are to be activated and which of the plurality of measurement configurations are not to be activated upon performing mobility to the second cell (e.g., the second cell being a primary cell) based on the second cell being a new serving cell for the WTRU and the mobility to the second cell causing an activation of a third cell of the plurality of mobility candidate cells as a secondary cell. The WTRU may determine the second measurement configuration to be activated.

The WTRU may be configured with a second type of measurement resource (e.g., a CSI-RS measurement resource configuration) and/or the WTRU may be configured to perform reporting using a second type of reporting (e.g., CSI reporting for reporting active SCells) when the cell is an activated SCell. The WTRU, therefore, may determine to apply the first type of measurement configuration and/or the first type of reporting based on the SpCell/SCell combination when the L1/L2 handover takes place (e.g., the SpCell/SCell combination which was configured by RRC and then activated/triggered using L1/L2 signalling such as MAC CE). The WTRU may subsequently determine to apply a second type of reporting and/or a second type of reporting when the SCell activation status changes (e.g., when a second MAC CE is received which changes the activation/deactivation status of a configured SCell). Alternatively or additionally, the WTRU may use any of the previously listed conditions (e.g., “X”) as first and/or second conditions. The first condition may be a condition which is applied upon executing a handover (e.g., L1/L2 triggered handover) using a particular condition (e.g., SpCell/SCell combination as preconfigured by RRC and triggered by MAC CE) and the second condition may be any subsequent configuration change (e.g., SCell activation/deactivation by MAC CE). The WTRU may perform one or more measurements associated with a second measurement configuration and send a measurement report via a second cell based on the measurements associated with the second measurement configuration.

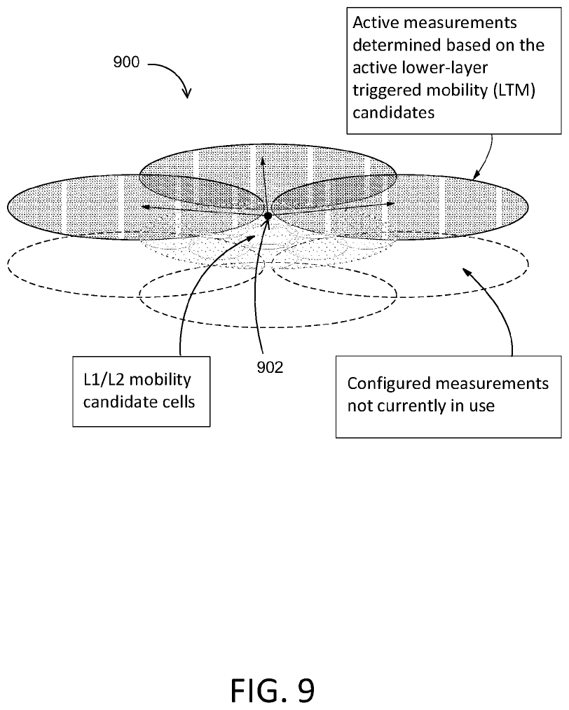

FIG. 9 shows an example of an L1/L2 mobility area 900. The WTRU (as represented by the solid black dot in the center of the mobility area) may be surrounded by L1/L2 mobility candidate cells. The WTRU may be configured to receive configuration information indicating a plurality of mobility candidate cells independently of the plurality of measurement configurations. That is, L1, L2, and/or Layer 3 (L3) mays send the information related to the mobility candidate cells separate from the plurality of measurement configurations. “Independent” may mean separate, in a different location, in a different signal, and/or in the same signal but in a different location, subblock, and/or portion of a signal. Another set of cells may have active measurements determined based on the active lower-layer triggered mobility (LTM) candidates. The lower layers may comprise the physical layer (PHY) and the medium-access control (MAC) layer. LTM may enable a serving cell change via L1/L2 signaling, while keeping configuration of the upper layers and/or minimizing changes of configuration of the lower layers. This may help to reduce the latency, overhead and interruption time during handover. The LTM may support both intra-distributed unit (DU) and intra-central unit (CU)-inter-DU mobility. During the LTM, user plane may continue when possible (e.g. intra-DU), without reset, with the target cell to avoid data loss and the additional delay of data recovery. A group of cells may have configured measurements not currently in use (e.g., due to the WTRU's position, trajectory, direction and/or speed of mobility, proximity to the cells).

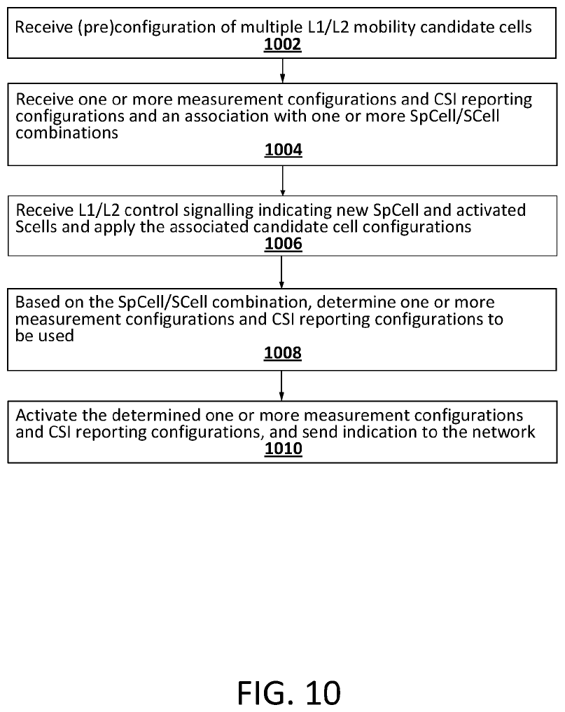

FIG. 10 shows a flowchart of an example procedure 1000 performed by a WTRU for measurement configurations with L1/L2 based mobility. At 1002, the WTRU may receive configuration information of multiple L1/L2 mobility candidate cells. The configuration information may indicate a plurality of mobility candidate cells and a plurality of measurement configurations. In some examples, the WTRU may be configured to receive the plurality of measurement configurations accompanied by an association with one or more special cell (SpCell)/secondary cell (SCell) combinations.

At 1004, the WTRU may receive from the network (e.g., independently from the L1/L2 candidate cells) one or more measurement configurations and CSI reporting configurations and an association with one or more SpCell/SCell combinations. For example, the WTRU may receive a first measurement configuration based on a first cell being a current serving cell for the WTRU. The WTRU may activate the first measurement configuration of a plurality of measurement configurations based on a first cell being a current serving cell for the WTRU. The WTRU may be configured to determine that a second measurement configuration is deactivated based on the first cell being a current serving cell for the WTRU. In some examples, the measurement configurations comprise channel state information (CSI) reporting configurations.

At 1006, the WTRU may receive L1/L2 control signalling indicating new SpCell and activated Scells and the WTRU may apply the associated candidate cell configurations. The Layer 1 or Layer 2 (L1/L2) control signalling may indicate that the WTRU is to perform mobility to at least a second cell, where the second cell is one of the plurality of mobility candidate cells (e.g., indicated by the configuration information received at 1002). In some examples, the L1/L2 control signaling may include (e.g., or be provided by way of) a medium access control (MAC) control element (CE). In some examples, the L1/L2 control signaling may indicate a new special cell (SpCell) and an activated secondary cell (Scell).

At 1008, based on the SpCell/SCell combination, the WTRU may determine one or more measurement configurations and CSI reporting configurations to be used. For examples, the WTRU may be configured to determine which of the plurality of measurement configurations are to be activated and which of the plurality of measurement configurations are not to be activated upon performing mobility to the second cell (e.g., the second cell being a primary cell) based on the second cell being a new serving cell for the WTRU and the mobility to the second cell causing an activation of a third cell of the plurality of mobility candidate cells as a secondary cell. The WTRU may determine the second measurement configuration to bei activated.

At 1010, The WTRU may activate the determined one or more measurement configurations and CSI reporting configurations and send an indication to the network. For example, the WTRU may perform one or more measurements associated with the second measurement configuration and send at least one measurement report via the second cell based on the measurements associated with the second measurement configuration.

The processes and instrumentalities described herein may apply in any combination, may apply to other wireless technologies, and for other services.

A WTRU may refer to an identity of the physical device, or to the user's identity such as subscription related identities, e.g., MSISDN, SIP URI, etc. WTRU may refer to application-based identities, e.g., user names that may be used per application.

The processes described above may be implemented in a computer program, software, and/or firmware incorporated in a computer-readable medium for execution by a computer and/or processor. Examples of computer-readable media include, but are not limited to, electronic signals (transmitted over wired and/or wireless connections) and/or computer-readable storage media. Examples of computer-readable storage media include, but are not limited to, a read only memory (ROM), a random access memory (RAM), a register, cache memory, semiconductor memory devices, magnetic media such as, but not limited to, internal hard disks and removable disks, magneto-optical media, and/or optical media such as CD-ROM disks, and/or digital versatile disks (DVDs). A processor in association with software may be used to implement a radio frequency transceiver for use in a WTRU, UE, terminal, base station, RNC, and/or any host computer.

What is claimed is:

1.-20. (canceled)

21. A wireless transmit/receive unit (WTRU) comprising:
a processor configured to:
receive configuration information indicating a plurality of mobility candidate cells and a plurality of measurement configurations;
activate a first measurement configuration based at least on a first cell being a serving cell for the WTRU;
receive layer 1 or layer 2 (L1/L2) control signaling indicating that the WTRU is to perform mobility to a second cell, the second cell being one of the plurality of mobility candidate cells;
determine to activate a second measurement configuration of the plurality of measurement configurations upon performing mobility to the second cell based on the second cell being a new serving cell for the WTRU and the mobility to the second cell causing an activation of a third cell of the plurality of mobility candidate cells as a secondary cell, wherein the second cell is a primary cell;
perform one or more measurements associated with the second measurement configuration; and
send a measurement report via the second cell based on the measurements associated with the second measurement configuration.

22. The WTRU of claim 21, wherein the L1/L2 control signaling comprises a medium access control (MAC) control element (CE).

23. The WTRU of claim 21, wherein the processor is further configured to receive the configuration information indicating the plurality of mobility candidate cells independently of the plurality of measurement configurations.

24. The WTRU of claim 21, wherein the L1/L2 control signaling indicates a new special cell (SpCell) and an activated secondary cell (SCell).

25. The WTRU of claim 21, wherein the processor is further configured to receive the plurality of measurement configurations accompanied by an association with one or more SpCell and SCell combinations.

26. The WTRU of claim 25, wherein the processor is configured to determine which of the plurality of measurement configurations are to be activated and which of the plurality of measurement configurations are not to be activated upon performing mobility to the second cell based on the one or more SpCell/SCell combinations.

27. The WTRU of claim 21, wherein the configuration comprising the plurality of mobility candidate cells and the plurality of measurement configurations is received in a radio resource control (RRC) message.

28. The WTRU of claim 21, wherein the one or more measurements associated with the second measurement configuration comprise channel state information (CSI) measurements.

29. The WTRU of claim 21, wherein the processor is configured with one or more dependencies between a set of location dependent configurations and a set of mobility functions.

30. The WTRU of claim 29, wherein the activation of one location dependent configuration activates one associated mobility function, and wherein the activation of one mobility function activates one associated location dependent configuration.

31. A method performed by a wireless transmit/receive unit (WTRU), the method comprising:
receiving configuration information indicating a plurality of mobility candidate cells and a plurality of measurement configurations;
activating a first measurement configuration based at least on a first cell being a serving cell for the WTRU;
receiving layer 1 or layer 2 (L1/L2) control signaling indicating that the WTRU is to perform mobility to a second cell, the second cell being one of the plurality of mobility candidate cells;
determining to activate a second measurement configuration of the plurality of measurement configurations upon performing mobility to the second cell based on the second cell being a new serving cell for the WTRU and the mobility to the second cell causing an activation of a third cell of the plurality of mobility candidate cells as a secondary cell, wherein the second cell is a primary cell;
performing one or more measurements associated with the second measurement configuration; and
sending a measurement report via the second cell based on the measurements associated with the second measurement configuration.

32. The method of claim 31, wherein the L1/L2 control signaling comprises a medium access control (MAC) control element (CE).

33. The method of claim 31, further comprising receiving the configuration information indicating the plurality of mobility candidate cells independently of the plurality of measurement configurations.

34. The method of claim 31, wherein the L1/L2 control signaling indicates a new special cell (SpCell) and an activated secondary cell (SCell).

35. The method of claim 31, further comprising receiving the plurality of measurement configurations accompanied by an association with one or more SpCell and SCell combinations.

36. The method of claim 35, further comprising determining which of the plurality of measurement configurations are to be activated and which of the plurality of measurement configurations are not to be activated upon performing mobility to the second cell based on the one or more SpCell/SCell combinations.

37. The method of claim 31, wherein the configuration comprising the plurality of mobility candidate cells and the plurality of measurement configurations is received in a radio resource control (RRC) message.

38. The method of claim 31, wherein the one or more measurements associated with the second measurement configuration comprise channel state information (CSI) measurements.

39. The method of claim 31, wherein the WTRU is configured with one or more dependencies between a set of location dependent configurations and a set of mobility functions.

40. The method of claim 39, wherein the activation of one location dependent configuration activates one associated mobility function, and wherein the activation of one mobility function activates one associated location dependent configuration.
